(19) United States
(12) Patent Application Publication
(10) Pub. No.: US 2020/0404137 A1
(43) Pub. Date: Dec. 24, 2020

(54) REFRIGERATOR AND CONTROL METHOD THEREOF

(71) Applicant: SAMSUNG ELECTRONICS CO., LTD, Suwon-si, Gyeonggi-do (KR)

(72) Inventors: Byoung Ik KANG, Suwon-si (KR); Myung Sik KIM, Suwon-si (KR)

(73) Assignee: SAMSUNG ELECTRONICS CO., LTD, Suwon-si, Gyeonggi-do (KR)

(21) Appl. No.: 16/977,640

(22) PCT Filed: Mar. 7, 2019
(86) PCT No.: PCT/KR2019/002657

§ 371 Date: Sep. 2, 2020

(30) Foreign Application Priority Data
Mar. 9, 2018 (KR) 10-2018-0027942

(51) Int. Cl. H04N 5/232; F25D 23/02; F25D 29/00

(52) U.S. Cl. CPC H04N 5/232; F25D 2700/02; F25D 29/005; F25D 23/028

(57) ABSTRACT

A refrigerator and a method of controlling the same are capable of controlling photography of a camera provided in the refrigerator and transmission of an image on the basis of opening and closing of a door and an acquired image to prevent personal information from leaking through the camera. The refrigerator includes a door rotatably coupled to a main body to open and close a storage compartment provided inside the main body, a camera configured to capture an image of an inside of the storage compartment; and a switch part configured to make a contact with the door and in response to the door being opened, interrupt supply of power for operating the camera.

### TECHNICAL FIELD

The disclosure relates to a refrigerator and a method of controlling the same, and more specifically, to a method of identifying food items stored in a refrigerator and safely processing an image taken by the refrigerator.

### BACKGROUND ART

A refrigerator is a device for keeping stored contents, such as food and beverage, for a long period of time without decaying, and is usually provided with a refrigerating compartment for keeping stored contents refrigerated and a freezing compartment for keeping stored contents frozen.

The refrigerator maintains the temperature of the storage compartment at a preset target temperature by repeatedly performing a refrigeration cycle of compression, condensation, expansion, and evaporation of a refrigerator. In other words, the refrigerator supplies storage compartments (a refrigerating compartment and/or a freezing compartment) with air cooled by an evaporator provided to correspond to each storage compartment based on a target temperature of the storage compartment, so that the temperature of the storage compartment is kept at the target temperature.

Recently, the refrigerator may further include a display for displaying the temperature of the storage compartment and the operation mode of the refrigerator. Such a display provides a user with a graphical user interface, and allows a user to easily acquire information related to the refrigerator and/or information related to food items using the graphical user interface and a touch panel and also allows a user to intuitively input a control command.

In particular, the refrigerator may display information about food items stored in the storage compartment through the display in response to a user input being inputted through the display, and manage information about each food item.

On the other hand, refrigerator models are getting diversified, and there is a low-cost refrigerator model having a camera installed on a refrigerator door for cost reduction, and in this case, when the refrigerator door is opened, the inside of r of a house may be photographed through the camera. Even when the photographing time is controlled by software, not only the inside of the refrigerator but also the outside of the refrigerator may be photographed by hacking, which may cause personal information infringement. Therefore, there is a need for a technology to prevent personal information from leaking to the outside through the camera.

### DISCLOSURE

### Technical Problem

One aspect of the disclosure provides a refrigerator and a method of controlling the same that are capable of controlling whether a camera provided in the refrigerator performs photography on the basis of opening and closing of a door and an acquired image and controlling transmission of an image to prevent personal information from leaking through the camera.

### Technical Solution

According to an aspect of the disclosure, there is provided a refrigerator including: a door rotatably coupled to a main body to open and close a storage compartment provided inside the main body; a camera configured to capture an image of an inside of the storage compartment; and a switch part configured to make a contact with the door and in response to the door being opened, interrupt supply of power for operating the camera.

The refrigerator may further include a controller configured to stop the camera from capturing the image by opening a circuit including the camera and the switch part when the door is opened.

The controller may stop the camera from capturing the image by turning off a power of the camera.

The controller may stop the camera from capturing the image by switching the camera into an inactive mode.

The controller may stop the camera from capturing the image by closing at least one of a shutter or an aperture of the camera.

The refrigerator may further include a memory configured to store the image, wherein the controller may delete the image when the image stored in the memory is determined as an image of an outside of the refrigerator.

The refrigerator may further include a display configured to output the image, and the controller may output a warning message including the image on the display.

The refrigerator may further include a communicator configured to communicate with at least one of a computing apparatus or user equipment.

The controller may determine whether the camera has captured the outside of the refrigerator on the basis of identification information received from the computing apparatus.

The controller may stop transmitting the image when an average transmission period of the image transmitted by the communicator is shorter than a predetermined period.

The controller may stop transmitting the image when an average transmission capacity of the image transmitted by the communicator exceeds a predetermined capacity.

The controller may stop transmitting the image when a difference between a point in time when the door is closed and a point in time when the image is transmitted by the communicator exceeds a predetermined time.

The controller may be configured to: match the user equipment and a user terminal with the refrigerator, and transmit a password command input by a user to at least one of the user equipment or the computing apparatus; and store the password command in the memory.

The controller may encrypt the image on the basis of the password command, and may transmit the encrypted image to at least one of the user equipment or the user terminal.

According to another aspect of the disclosure, there is provided a method of controlling a refrigerator, the method including: capturing, by a camera, an image of an inside of a storage compartment provided inside a main body to which a door is coupled; and interrupting, by the camera, supply of power in response to the door being opened.

The method may further include: stopping the camera from capturing the image by opening a circuit including the camera and the switch part when the door is opened.

The stopping of the camera from capturing the image may include stop the camera from capturing the image by turning off a power of the camera.

The stopping of the camera from capturing the image may include stopping the camera from capturing the image by switching the camera into an inactive mode.

The stopping of the camera from capturing the image may include stopping the camera from capturing the image by closing at least one of a shutter or an aperture of the camera.

The method may further include storing the image, and deleting the image when the image stored in the memory is determined as an image of an outside of the refrigerator.

The method may further include outputting a warning message including the image.

The method may further include determining whether the camera has captured the outside of the refrigerator on the basis of identification information received from the computing apparatus.

The method may further include stopping transmitting the image when an average transmission period of the image transmitted by the communicator is shorter than a predetermined period.

The method may further include stopping transmitting the image when an average transmission capacity of the image transmitted by the communicator exceeds a predetermined capacity.

The method may further include stopping transmitting the image when a difference between a point in time when the door is closed and a point in time when the image is transmitted by the communicator exceeds a predetermined time.

The method may further include: matching the computing apparatus with the refrigerator, and transmitting a password command input by a user to at least one of the user equipment or the computing apparatus; and storing the password command in the memory.

The method may further include encrypting the image on the basis of the password command, and transmitting the encrypted image to at least one of the user equipment or the user terminal.

### Advantageous Effects

As is apparent from the above, the refrigerator and the control method according to the embodiment may control whether the camera is photographed and the transmission of the image on the basis of the opening and closing of the door and the acquired image so that personal information does not leak through the camera provided in the refrigerator.

### DESCRIPTION OF DRAWINGS

FIG. 1 shows a food management system according to an embodiment.

FIG. 2 shows the external appearance of a refrigerator according to an embodiment.

FIG. 3 shows a front surface of a refrigerator according to an embodiment.

FIG. 4 shows a configuration of a refrigerator according to an embodiment.

FIG. 5 shows a touch screen display included in a refrigerator according to an embodiment.

FIG. 6 is a view showing a switch part according to an embodiment.

FIG. 7 shows a circuit included in a refrigerator according to an embodiment.

FIGS. 8A and 8B show an interior image and an exterior image of the refrigerator captured according to an embodiment.

FIG. 9 shows an example in which a food item is identified by an object identification engine included in a computing apparatus according to an embodiment.

FIG. 10 shows an example in which an image is deleted according to an embodiment.

FIG. 11 shows an example in which an image transmission command is received according to an embodiment.

FIG. 12 shows an example of an operation of identifying an image using a computing apparatus according to one embodiment.

FIG. 13 shows an example of an operation of transmitting password information of a refrigerator according to an embodiment.

FIG. 14 is a graph showing a point in time when a door is closed and a point in time when an image is transmitted according to an embodiment.

FIGS. 15 to 19 are flowcharts according to an embodiment.

### MODES OF THE DISCLOSURE

Like numerals refer to like elements throughout the specification. Not all elements of embodiments of the present disclosure will be described, and description of what are commonly known in the art or what overlap each other in the embodiments will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Further, when it is stated that a layer is “on” another layer or substrate, the layer may be directly on another layer or substrate or a third layer may be disposed therebetween.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the principles and embodiments of the disclosure will be described with reference to the accompanying drawings.

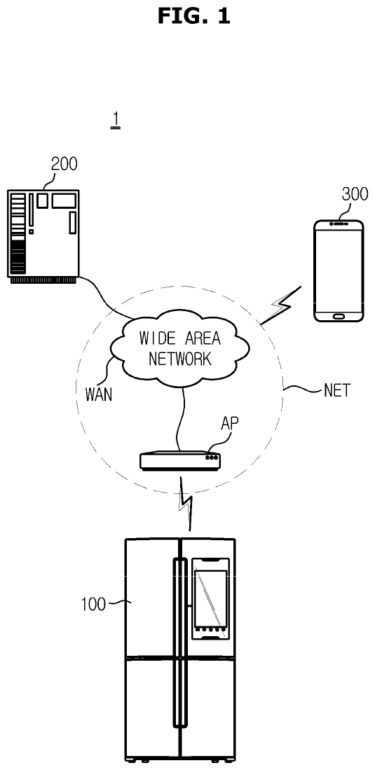

FIG. 1 shows a food management system according to an embodiment.

Referring to FIG. 1, a food management system 1 includes a refrigerator 100 to store food items, a computing apparatus 200 to identify (or recognize) food items stored in the refrigerator 100, and a user equipment 300 to provide a user with information related to the identified (or recognized) food item.

The refrigerator 100, the computing apparatus 200, and the user equipment 300 included in the food management system 1 may be connected to each other through a communication network (NET). In this case, the NET may include both a wired communication network and a wireless communication network. The wired communication network includes a communication network, such as a cable network or a telephone network, and the wireless communication network may include a communication network that transmits and receives signals through radio waves. The wired communication network and the wireless communication network may be connected to each other. For example, the wired communication network may include a wide area network (WAN), such as the Internet, and the wireless communication network may include an access point (AP) connected to the WAN.

The refrigerator 100 may store food items in a refrigerated state or frozen state. For example, the refrigerator 100 may include a storage compartment that accommodates food and a cooling device that cools the storage compartment. The refrigerator 100 may supply the storage compartment with cold air using the cooling device to prevent food deterioration.

The refrigerator 100 may provide the user with information related to food stored in the storage compartment in response to a user's request. For example, the refrigerator 100 may photograph the storage compartment where food is stored and may acquire an image of an inside of the storage compartment. In order to obtain information related to food stored in the storage compartment, the refrigerator 100 may transmit the acquired image of the inside of the storage compartment to the computing apparatus 200 through a communication network NET. In addition, the refrigerator 100 may receive identification information and food related information that are related to the food stored in the storage compartment, and display the received food related information or transmit the received food related information to the user equipment 300.

The computing apparatus 200 may process data from another apparatus through the NET, store the processed data, or transmit the processed data to another apparatus. For example, the computing apparatus 200 may include a communication unit that may communicate with another apparatus, a processing unit that may process data, and a storage medium that may store the processed data. Such a computing apparatus 200 may be referred to as a server, a client, a workstation, a personal computer, a cloud, a data drive, a data station, and the like.

The computing apparatus 200 may include object recognition that may identify an object. For example, the computing apparatus 200 may include object identification that may identify an object included in an image using machine learning. The computing apparatus 200 may receive an image of the inside of the storage compartment from the refrigerator 100 through the NET, and identify a food item (i.e., a food item stored in the storage compartment) included in the image of the inside of the storage compartment. The computing apparatus 200 may store information related to the identified food item, or transmit the information related to the identified food item to the refrigerator 100 and/or the user equipment 300. Here, the information related to the identified food item may include the image of the identified food item, the name of the identified food, the category of the identified food item, the shelf life of the identified food item, and the like.

Meanwhile, when an object other than food item is included in an image acquired by the refrigerator, the computing apparatus may determine the image acquired by the refrigerator as an image of the outside of the refrigerator. The computing apparatus may determine whether an object located outside the refrigerator, such as a person or furniture, is included through the above described object recognition. The computing apparatus may transmit identification information including the above described information to the refrigerator.

The user equipment 300 may process data from another apparatus through the NET and display the processed data to a user. In particular, the user equipment 300 may be carried by a user, or may be disposed at home or office of the user, and the user may easily access the user equipment 300. The user equipment 300 may be referred to as a workstation, a personal computer, a terminal, a portable telephone, a smart phone, a handheld device, a wearable device, and the like.

The user equipment 300 may receive information related to food items stored in the refrigerator 100 from the refrigerator 100 and/or the computing apparatus 200, and display the information related to the food items stored in the refrigerator 100. For example, the user equipment 300 may display the name, image, category, and shelf life of the food item stored in the refrigerator 100.

As described above, the food management system 1 may acquire an image of an inside of the storage compartment by photographing the storage compartment of the refrigerator 100, and identify food items included in the image of the inside of the storage compartment. In other words, the food management system 1 may identify food items stored in the storage compartment using the image of the inside of the storage compartment. As described above, the food management system 1 may identify whether the image acquired by the refrigerator is an exterior image of the refrigerator. Further, the food management system 1 may provide a user with information related to food items stored in the storage compartment on the basis of the identification result.

As a result, even when a user does not input information related to food items stored in the refrigerator 100, the refrigerator 100 may identify the food items using the computing apparatus 200 and obtain information related to the stored food items.

Hereinafter, the configuration and operation of the refrigerator 100 included in the food management system 1 will be described.

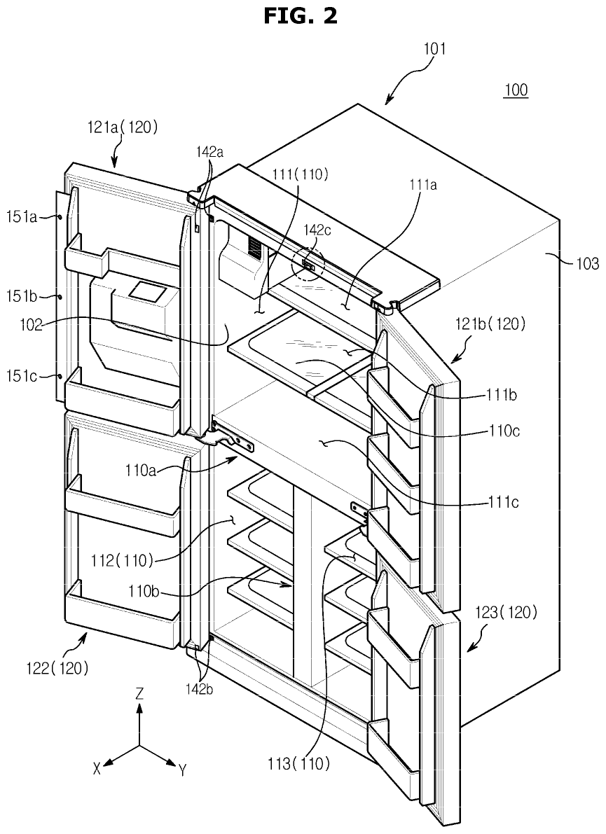

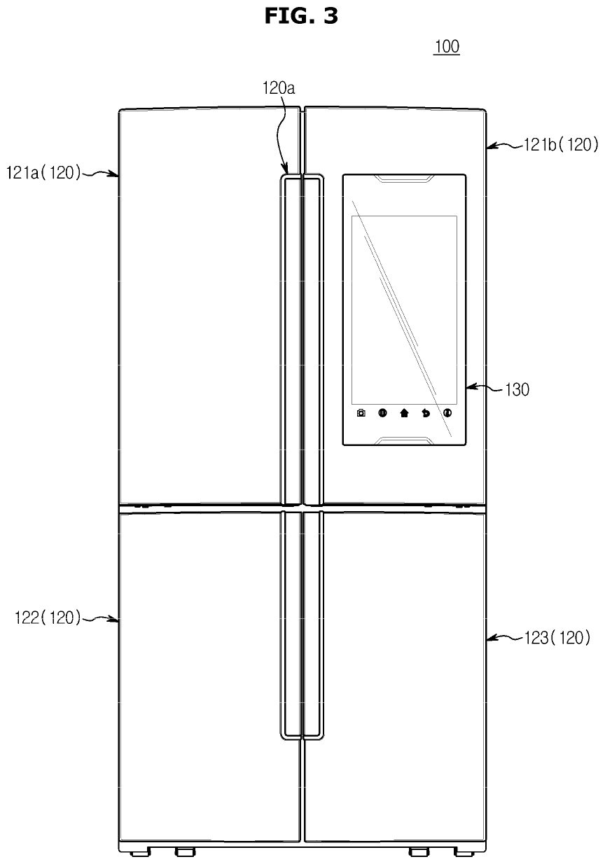

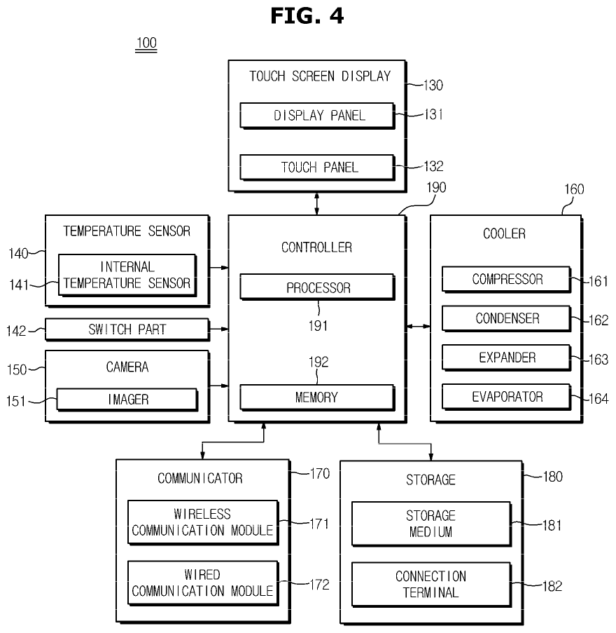

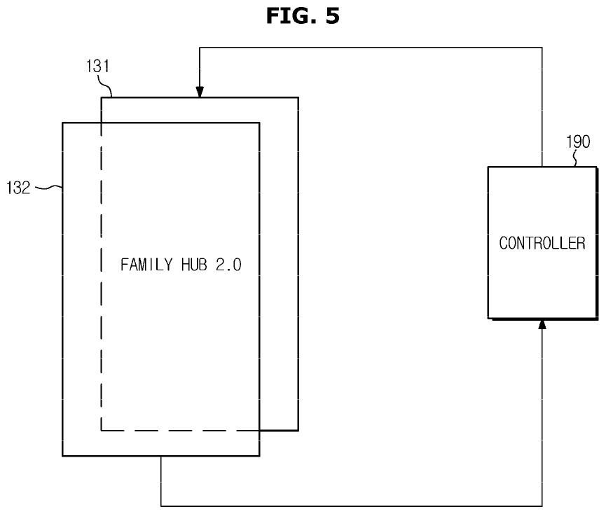

FIG. 2 shows the external appearance of a refrigerator according to an embodiment. FIG. 3 shows a front surface of a refrigerator according to an embodiment. FIG. 4 shows a configuration of a refrigerator according to an embodiment. FIG. 5 shows a touch screen display included in a refrigerator according to an embodiment.

Referring of FIGS. 2, 3, 4, and 5, the refrigerator 100 includes a main body 101 with an open front surface, a storage compartment 110 formed inside the main body 101 and storing food items in a refrigerated state or frozen state, and a door 120 configured to open and close the open front surface of the main body 101.

The main body 101 may form the external appearance of the refrigerator 100. The main body 101 includes an inner case 102 forming the storage compartment 110 and an outer case 103 coupled to an outer side of the inner case 102 to form the external appearance. Between the inner case 102 and the outer case 103 of the main body 101, a heat insulating material (not shown) for preventing cold air from flowing out of the storage compartment 110 may be filled.

The storage compartment 110 may be divided into a plurality of areas by a horizontal partition wall 110a and a vertical partition wall 110b. For example, as illustrated in FIG. 2, the storage compartment 110 may be divided into an upper storage compartment 111, a first lower storage compartment 112, and a second lower storage compartment 113.

The storage compartment 110 may be provided with a shelf 110c on which food items may be placed. A storage space inside the storage compartment 110 may be divided by the shelf 110c. For example, the upper storage compartment 111 may be divided into a first storage space 111a, a second storage space 111b, and a third storage space 111c.

The storage compartment 110 may be opened and closed by the door 120. For example, as illustrated in FIG. 2, the upper storage compartment 111 may be opened and closed by an upper first door 121a and an upper second door 121b, and the first lower storage compartment 112 may be opened and closed by a first lower door 122, and the second lower storage compartment 113 may be opened and closed by a second lower door 123

The door 120 may be provided with handles 120a provided to easily open and close the door 120. The handles 121 may be provided between the first upper door 121a and the second upper door 121b and between the first lower door 122 and the second lower door 123 in a lengthwise direction. Therefore, when the door 120 is closed, the handles 120a may appear to be a unitary body.

Meanwhile, switch parts 142a, 142b, and 142c may be provided between the door and the main body. According to an embodiment of the disclosure, the switch parts 142a, 142b, and 142c may sense the pressure by the door and may vary the output depending on whether the door is opened or closed. Details of the switch parts 142a, 142b, and 142c will be described below. In addition, referring to FIG. 4, the refrigerator 1 may include a touch screen display 130, a temperature sensor 140, a camera 150, a cooler 160, a communicator 170, a storage 180, and a controller 190.

The touch screen display 130 may include a display panel 131 to display an image and a touch panel 132 to receive a touch input.

The display 130 may output an image acquired by the camera 150. Specifically, the display 130 may output an image of a food item in the storage compartment captured by the camera 150. In addition, as will be described below, when the camera 150 captures an image of an outside of the refrigerator, the display 130 may output a warning message that an image other than an interior image of the refrigerator has captured. In addition, according to an embodiment, when the image captured by the camera 150 is transmitted to the computing apparatus or the user equipment, the display 130 may output the image acquired by the camera 150 on the display 130. The display panel 131 may convert image data received from the controller 190 into an optical signal that is visible to the user, as shown in FIG. 5.

The display panel 131 may employ a liquid crystal display (LCD) panel, a light emitting diode (LED) panel, an organic light emitting diode (OLED) panel, a micro light emitting diode (uLED) panel, a plasma display panel (PDP), and the like. However, the display panel 131 is not limited thereto, and may be variously provided as long as it can visually display an optical image corresponding to image data.

Referring to FIG. 5, the touch panel 132 may receive a user's touch input and may output an electrical signal corresponding to the received touch input to the controller 190.

For example, the touch panel 132 may detect a user's touch on the touch panel 132 from a change in electrical resistance value or a change in capacitance, and output an electrical signal corresponding to coordinates of the user's touch point to the controller 190. The controller 190 may identify the coordinates of the user's touch point on the basis of the electrical signal received from the touch panel 132. In addition, the controller 190 identifies the user input on the basis of the coordinates of the user's touch point.

The touch panel 132 may be located on a front surface of the display panel 131. In other words, the touch panel 132 may be provided on a surface on which an image is displayed. Accordingly, the touch panel 132 may be formed of a transparent material to prevent an image displayed on the display panel 131 from being distorted.

The touch panel 132 may employ a resistive touch panel or a capacitive touch panel. However, the touch panel 132 is not limited thereto, and may be variously provided as long as it can detect a user's touch or approach, and output an electrical signal corresponding to coordinates of the detected touch point or coordinates of the approach point.

As such, the touch screen display 130 may receive a touch input from a user, transmit the received touch input to the controller 190, and may display an image of the controller 190 in response to the user's touch input. In other words, the touch screen display 130 may interact with the user.

According to an embodiment, when it is determined that the camera 150 has captured the exterior image, the touch panel 132 may delete the image by receiving a user command. In addition, according to an embodiment, when transmitting an image captured by the camera 150 to the computing apparatus or the user equipment, the display 130 may output the image acquired by the camera 150 on the display 130 and may transmit the image to the computing apparatus or the user equipment on the basis of a command input by the user through the touch panel. The touch screen display 130 may be installed on the door 120 for the user convenience. For example, as shown in FIG. 3, the touch screen display 130 may be installed on the second upper door 121b. The following description is made in relation to the touch screen display 130 installed on the second upper door 121b, but the installation position of the touch screen display 130 is not limited to the upper second door 121b. For example, the touch screen display 130 may be variously installed on the first upper door 121a, the first lower door 122, the second lower door 123, the outer case 103 of the main body 10, or other various positions where the touch screen display 130 is visible to a user.

In addition, the touch screen display 130 may be provided with a wake up function that is automatically activated when a user approaches an area within a certain range. For example, when the user approaches an area within a certain range, the touch screen display 130 may be activated. In other words, the touch screen display 130 may be switched into an on-state. In addition, when a certain time elapses after the user leaves the area within the certain range, the touch screen display 130 may be deactivated. In other words, the touch screen display 130 may be switched into an off-state.

The temperature sensor 140 may include internal temperature sensors 141 that may be provided inside the storage compartment 110 and detect the internal temperature of the storage compartment 110.

The internal temperature sensors 141 may each be installed in the plurality of storage compartments 111, 112, and 112 to detect the temperature of each of the storage compartments 111, 112, and 113, and output an electrical signal corresponding to the detected temperature to the controller 190. Each of the internal temperature sensors 141 may include a thermistor whose electrical resistance changes with temperature.

The camera 150 is installed inside the storage compartment 110 to acquire the interior image of the storage compartment 110. For example, as shown in FIG. 2, the camera 150 may be installed at an inner side of the door 120, and capture an image in a direction toward the inside of the storage compartment 110 from the inner side of the door 120. Therefore, the camera 150 may photograph the inside of the storage compartment 110 in a direction substantially identical to that of a user's gaze direction. In addition, the camera 150 may photograph the outside of the refrigerator when the door is open.

The camera 150 may include an imager 151 that captures an image and converts the captured image into an electrical signal. The imager 151 may include a plurality of photodiodes that convert an optical signal into an electrical signal. The plurality of photodiodes may be arranged in two dimensions. The imager 151 may include, for example, a charge-coupled device (CCD) image sensor or a complementary metal oxide semiconductor (CMOS) image sensor.

The camera 150 may include a plurality of imagers 151a, 151b, and 151c to photograph the inside of the storage compartment 110 partitioned by the shelf 110c. For example, the camera 150 may include a first imager 151a to photograph the first storage space 111a, a second imager 151b to photograph the second storage space 111b, and a third imager 151c to photograph the third storage space 111c.

In particular, when a food item is stored in the storage compartment 110, the interior image of the storage compartment 110 captured by the camera 150 may include an image of the food item stored in the storage compartment 110.

In addition, when the camera 150 photographs the outside of the refrigerator, the image photographed by the camera may include an image of a person or an image of furniture outside the refrigerator. The camera 150 may transmit the captured image to the controller 190. Specifically, the camera 150 may transmit the interior image of the storage compartment 110 including the image of the food item to the controller 190, and may also transmit the exterior image of the refrigerator captured by the camera 150.

The cooler 160 may supply cold air to the storage compartment 110. Specifically, the cooler 160 may maintain the temperature of the storage compartment 110 within a range specified by a user using evaporation of a refrigerant.

The cooler 160 includes a compressor 161 for compressing a gas refrigerant, a condenser 162 for converting the compressed gas refrigerant into a liquid refrigerator, an expander 163 for decompressing the liquid refrigerant, and an evaporator 164 for converting the decompressed liquid refrigerant into a gas refrigerant.

The cooler 160 may cool air in the storage compartment 110 using a phenomenon that a liquid refrigerant while being converted into a gas refrigerant absorbs thermal energy of the ambient air.

However, the cooler 160 is not limited to including the compressor 161, the condenser 162, the expander 163, and the evaporator 164.

For example, the cooler 160 may include a Peltier element using the Peltier effect. The Peltier effect refers to a phenomenon that when a current flows through a contact surface between different types of metal, generation of heat occurs in one metal and absorption of heat occurs in the other metal. The cooler 160 may cool the air in the storage compartment 110 using the Peltier element.

As another example, the cooler 160 may include a magnetic cooling device using a magneto-caloric effect. A magnetic heat effect refers to a phenomenon that a specific material (a magneto-caloric material), when magnetized, releases heat and when demagnetized, absorbs heat. The cooler 160 may cool air in the storage compartment 110 using the magnetic cooling device.

The communicator 170 may exchange data with the computing apparatus 200 and/or the user equipment 300. For example, the communicator 170 may transmit the interior image or exterior image of the storage compartment captured by the camera 150 to the computing apparatus 200, and may receive information related to food items included in the interior image of the storage compartment from the computing apparatus 200. In addition, the computing apparatus 200 may receive data, determine whether an image captured by the camera is an interior image or an exterior image of the refrigerator, and derive identification information, and may transmit the identification information to the refrigerator. The communicator may receive the identification information transmitted by the computing apparatus. The identification information may include information for specifying the type of an object included in the image acquired by the refrigerator.

The communicator 170 may include a wired communication module 172 exchanging data with the computing apparatus 200 and/or the user equipment 300 in a wired manner and a wireless communication module 171 exchanging data with the computing apparatus 200 and/or the user equipment 300 in a wireless manner.

The wired communication module 172 may be connected to a communication network and communicate with the computing apparatus 200 and/or the user equipment 300. For example, the wired communication module 172 is connected to a wired communication network through Ethernet (Ethernet, IEEE 802.3 technology standard), and receive data from the computing apparatus 200 and/or the user equipment 300.

The wireless communication module 171 may wirelessly communicate with a base station or an access point (AP), and connect to a wired communication network through the base station or the AP. The wireless communication module 171 may communicate with the computing apparatus 200 and/or the user equipment 300 connected to the wireless communication network via the base station or the access point. For example, the wireless communication module 171 may communicate with the AP through Wi-Fi (WiFi™, IEEE 802.11 technology standard), or communicate with the base station using a code division multiple access (CDMA), a wideband code division multiple access (WCDMA), a global system for mobile communication (GSM), a Long Term Evolution (LTE), a wireless broadband module (WIBRO), and the like. The wireless communication module 171 may receive data from the computing apparatus 200 and/or the user equipment 300 via the base station or the AP.

In addition, the wireless communication module 171 may communicate directly with the computing apparatus 200 and/or the user equipment 300. For example, the wireless communication module 171 may wirelessly receive data from the computing apparatus 200 and/or the user equipment 300 using Wi-Fi, Bluetooth (Bluetooth™, and IEEE 802.15 . . . 1 technology standard), ZigBee (ZigBee™, IEEE 802.15.4 technology standard), and the like.

As such, the communicator 170 may exchange data with the computing apparatus 200 and/or the user equipment 300, and may output the data received from the computing apparatus 200 and/or the user equipment 300 to the controller 190.

In addition, the communicator 170 may transmit a password command input by the user through the touch panel to at least one of the user equipment or the computing apparatus. The computing apparatus and the user equipment matched with the refrigerator may be synchronized through the password command input through the refrigerator.

The storage 180 may include a storage medium 181 that stores programs and/or data, and a connection terminal 182 that may be connected to an external storage medium in which programs and/or data are stored. The program includes a plurality of instructions combined to perform a specific function, and data may be processed by the plurality of instructions included in the program. In addition, the program and/or data may include a system program and/or system data directly associated with the operation of the refrigerator 100, and an application program and/or application data that provide the user with convenience and fun. The storage medium 181 may store the program and/or data in the form of a file. For example, the storage medium 181 may store the program and/or data in the form of a file, such as “*.exe” or “*.jpg” or “*.mpg”.

The storage medium 181 may electrically or magnetically or optically store content data. For example, the storage medium 181 may include a large capacity storage device (a flash memory), a solid state drive (SSD), a hard disk drive (HDD), or an optical disc drive (ODD).

The storage medium 181 may output the program and/or data to the controller 190 in response to a loading command of the controller 190.

The connection terminal 182 may be connected to an external storage medium that stores programs and/or data. For example, the connection terminal 182 may include a universal serial bus (USB) terminal, and may be connected to an external USB storage medium.

The external storage medium may also store programs and/or data in the form of a file, similar to the storage medium 181 of the refrigerator 100, and may store programs and/or data electrically, magnetically, or optically. The external storage medium may output programs and/or data to the controller 190 through the connection terminal 182 in response to a loading command of the controller 190.

As such, the storage 180 may store programs and/or data, and output the stored programs and/or data to the controller 190. In other words, the storage 180 may store programs and/or data executed for the controller 190 to perform operations described below.

The controller 190 includes a memory 192 that loads programs and/or data stored in the storage 180 and memorizes the programs and/or data and a processor 191 that processes user input data of the touch screen display 130 and communication data of the communicator 170. The controller 190 may not only include hardware, such as the memory 192 and the processor 191, but also include software, such as programs and/or data memorized by the memory 192 and processed by the processor 191.

The memory 192 may memorize programs and/or data for controlling components included in the refrigerator 100, and memorize temporary data generated in the process of controlling the components included in the refrigerator 100. The memory may store images captured by the camera. For example, the memory 192 may memorize programs and/or data for controlling the operation of the cooler 160 on the basis of a detection result of the temperature sensor 140, and may temporarily memorize the detection result of the temperature sensor 140. The memory 192 may memorize programs and/or data for controlling the operation of the touch screen display 130, and may temporarily memorize an image displayed on the touch screen display 130 and a touch input inputted through the touch screen display 130 (a user input). The memory 192 may memorize programs and/or data for controlling a photography operation of the camera 150 on the basis of opening and closing of the door 120, and may temporarily memorize an image captured by the camera 150. The memory 192 may store programs and/or data for controlling a communication operation of the communicator 170, and temporarily transmit and receive communication data transmitted and received by the communicator 170. In addition, the memory 192 may memorize programs and/or data required for the refrigerator 100 to perform the operations described below.

The memory 192 may include a non-volatile memory for storing data for a long period of time, such as a read only memory (ROM), a flash memory, and the like, and a volatile memory for temporarily memorizing data, such as static random access memory (S-RAM), a dynamic random access memory (D-RAM), and the like.

The processor 191 may process a touch input of the touch screen display 130 and/or communication data of the communicator 170 according to the programs and/or data memorized/stored in the memory 192, and may generate a control signal for controlling the operation of the touch screen display 130 and/or the operation of the communicator 170.

For example, the processor 191 may receive temperature information of the storage compartment 110 from the temperature sensor 140, and generate a cooling control signal for controlling the operation of the cooler 160 on the basis of the temperature information of the storage compartment 110. The processor 191 may receive a user's touch input from the touch screen display 130 and transmit a display control signal and image data for displaying an image on the touch screen display 130 in response to the user's touch input to the touch screen display 130. The processor 191 may generate a photography control signal for the camera 150 to photograph the inside of the storage compartment 110 immediately after the door 120 is closed, and receive the interior image of the storage compartment 110 from the camera 150. The processor 191 may generate a communication control signal for controlling the communicator 170 to transmit the interior image of the storage compartment 110 to the computing apparatus 200 in response to receiving the interior image of the storage compartment 110 from the camera 150. The processor 191 may generate a display control signal for displaying food related information in response to receiving information related to a food item stored in the storage compartment 100 from the computing apparatus 200 through the communicator 170. In addition, the processor 191 may generate a control signal for the refrigerator 100 to perform the operations described below.

The processor 191 in response to determining that the door is open based on the output of the switch part 142, may stop photography of the camera 150. The camera 150 may stop photography as power being turned off based on the output of the switch part 142, or stop photography as the controller controls the camera to be switched into an inactive mode based on the output of the switch part 142.

The processor 191, in response to determining that the image stored in the memory is an image of the outside of the refrigerator, may delete the image. The determination of whether the image captured by the camera 150 is an image of an inside or outside of the refrigerator may be performed by the computing apparatus. The processor 191 may determine whether the camera has photographed the inside or the outside of the refrigerator based on the identification information transmitted from the computing apparatus to the communicator 170.

The processor 191 may include a core for performing logical operations and arithmetic operations, and a register for storing the calculated data.

As such, the controller 190 may control the cooler 160, the touch screen display 130, and the communicator 170 on the basis of the temperature of the storage compartment 110 obtained through the temperature sensor 140, the user's touch input obtained through the touch screen display 130, and/or the communication data obtained through the communicator 170.

As described above, the controller 190 may include the processor and the memory that control all of the components included in the refrigerator 100, and the controller 190 may include a plurality of the processors and a plurality of the memories. For example, the controller 190 may include a processor and a memory that control the operation of the temperature sensor 140, a processor and a memory that control the operation of the cooler 160, a processor and a memory that control the operation of the touch screen display 130, and a processor and a memory that control the operation of the communicator 170.

The switch part 142 may be provided as a configuration that varies the output according to the opening and closing of the door of the refrigerator.

According to an embodiment, in a state of no pressure being applied to the switch part 142, the door is determined open, and the switch may output a signal for the controller to perform control to cause the camera not to capture an image as will be described below. As another example, in a state of no pressure being applied to the switch part 142, the switch part 142 may be provided to interrupt power of the camera itself. Details of the switch part 142 will be described below.

At least one component may be added or omitted to correspond to the performances of the components of the refrigerator shown in FIG. 4. In addition, it would be understood by those skilled in the art that the mutual positions of the components may be changed to correspond to the performance or structure of the system.

Meanwhile, the components shown in FIG. 4 may refer to a software component and/or a hardware component, such as a Field Programmable Gate Array (FPGA) and an Application Specific Integrated Circuit (ASIC).

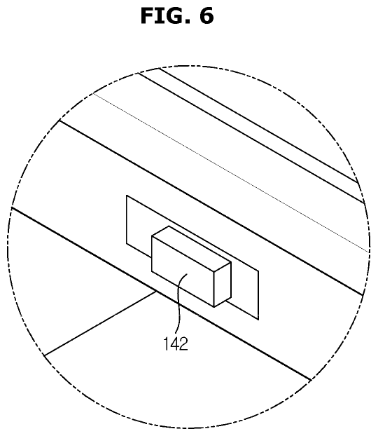

FIG. 6 is a view showing a switch part according to an embodiment.

Referring to FIG. 6, the switch part 142 may be embodied in the form of being directly pressurized by the door. Specifically, when the door is closed, the switch part 142 pressurized by the door may provide an output indicating that the door is closed, and when the door is opened, the switch part 142 not pressurized by the door may provide an output indicating that the door is open. That is, when the door is closed, the switch part 142 may supply power to the camera while in contact with the door. In addition, when the door is opened, the switch part 142 may not come into contact with the door without being pressurized by the door.

That is, the switch part may interrupt power supply for the operation of the camera as the door is opened. In addition, the switch part being pressurized or not pressurized, or the switch part coming in contact with or not in contact with the door may represent a form of the output of the switch part.

The form of the output of the switch part may not be limited as long as it varies depending on whether the door is opened or not. In addition, the switch part may be variously implemented as long as the switch part varies the output depending on the opening and closing of the door. Meanwhile, the switch part 142 may be implemented in a form including at least one sensor provided to detect whether the door is opened or closed. The switch part 142 may be formed as one sensor or two sensors.

Here, when the switch part 142 is provided as one sensor, the switch part 142 may be provided as a proximity sensor that is disposed on one of the door and the main body to detect mutual access, or may be provided as a photo sensor that serves both as a transmitter and a receiver.

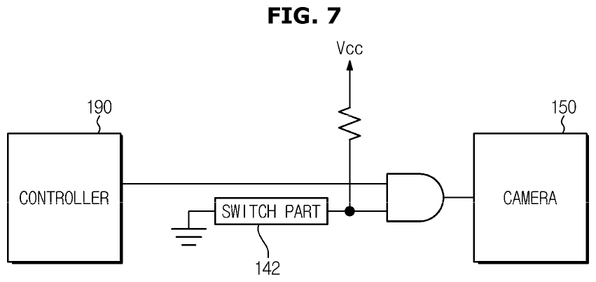

FIG. 7 shows a circuit included in a refrigerator according to an embodiment.

Referring to FIG. 7, the controller 190 may be connected to the camera 150 through the switch part 142. The camera 150 may transmit an image acquired by being electrically connected to the controller 190 to the controller 190. The controller 190 may store the image acquired by the camera 150. In addition, the camera 150 may be connected to the switch part 142. As described above, the switch part 142 may be connected to the camera 150 and vary the output. The switch part 142 may be connected to a power supply Vcc to connect or interrupt power supplied to the camera 150. According to an embodiment, when the door of the refrigerator is opened, the switch part 142 may provide an output to open the circuit.

According to another embodiment, the switch part 142 may be connected to the controller 190. The controller 190 may determine whether the door of the refrigerator is open or closed through the switch part 142. When it is determined that the door is open, the controller may allow power supplied to the camera to be interrupted. According to still another embodiment, the controller may switch the camera into an inactive mode. The inactive mode may be implemented in the form of blocking the connection between the camera and the controller, but the form of the inactive mode is not limited as long as the camera is prevented from capturing an image. In addition, when it is determined that the door is open, the controller may close at least one of a shutter or an aperture provided in the camera to stop photography.

In FIG. 7, various embodiments of stopping photography of the camera using the switch part have been described, but the form of stopping the camera from photography is not limited thereto.

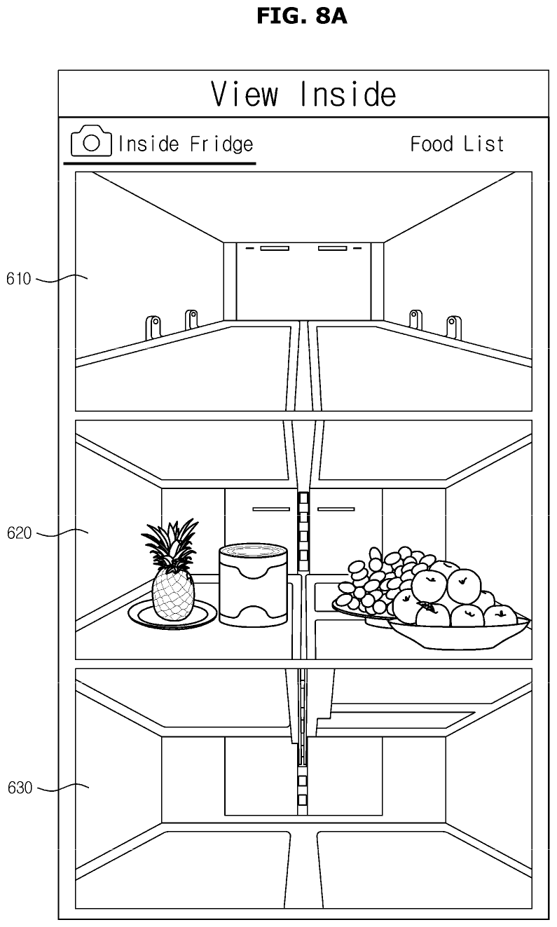

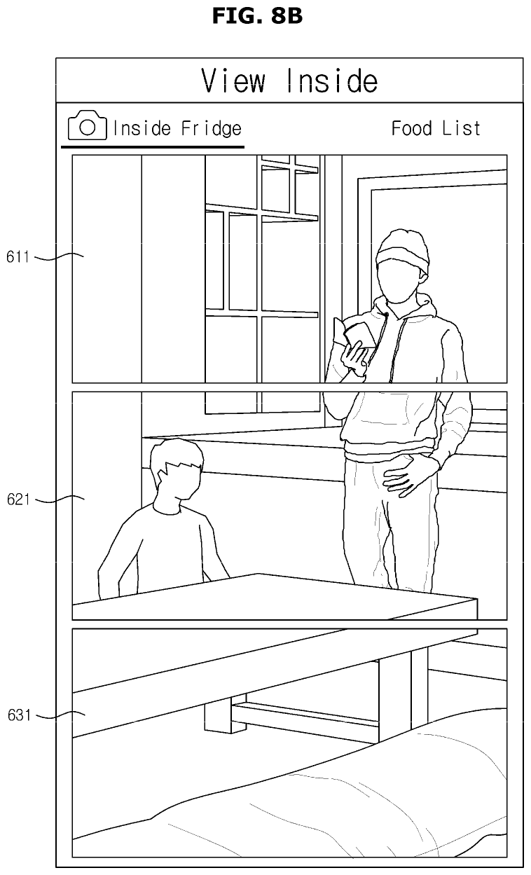

FIGS. 8A and 8B show an interior image and an exterior image of the refrigerator captured according to an embodiment.

Referring to FIG. 8A, the refrigerator 100 may photograph the inside of the storage compartment 110 through the camera 150 and acquire an interior image of the storage compartment 110.

The controller 190 may control the camera 150 to photograph the inside of the storage compartment 110 in response to detecting that the door 120 having been open is closed. The controller 190 may acquire interior images 610, 620, and 630 of the storage compartment 110 from the camera 150.

As another example, the controller 190 may control the camera 150 to photograph the inside of the storage compartment 110 in response to a user input being inputted through the touch screen display 130, and acquire the interior images of the storage compartment 110 from the camera 150.

In addition, the controller 190 may display the interior images of the storage compartment 110 captured by the camera 150 on the touch screen display 130. The refrigerator 100 transmits the interior image of the storage compartment 110 to the computing apparatus 200, and the computing apparatus 200 receives the interior image 610, 620 and 630 of the storage compartment 110 from the refrigerator 100 (1120).

The refrigerator 100 may transmit the interior images of the storage compartment 110 to the computing apparatus 200 through the NET. The controller 190 may control the communicator 170 to transmit the interior image of the storage compartment 110 to the computing apparatus 200.

The computing apparatus 200 may receive the interior images 610, 620, and 630 of the storage compartment 110 from the refrigerator 100 through the NET. The computing apparatus 200 may identify food items included in the interior image of the storage compartment 110.

Referring to FIG. 8B, when the door is opened, the refrigerator 100 may photograph the outside of the refrigerator through the camera 150 and acquire exterior images 611,621, and 631 of the refrigerator.

The camera may be provided on the door in the refrigerator. Therefore, when the door is open, the camera may acquire the images 611, 621, and 631 of the outside of the refrigerator.

The controller 190 may control the camera 150 to photograph the inside of the storage compartment 110 in response to detecting that the door 120 having been open is closed. In addition, the controller may control the camera to acquire the images 611, 621, and 631 of the outside of the refrigerator in a state of the door being open.

Meanwhile, the refrigerator may transmit the acquired images to the computing apparatus. The computing apparatus 200 may identify food items included in the interior and exterior images of the storage compartment 110 using a trained object identification engine 231. The computing apparatus may determine whether the image acquired by the refrigerator is an image of the inside of the refrigerator or an image of the outside of the refrigerator using the trained object identification engine. Detailed operations thereof will be described below.

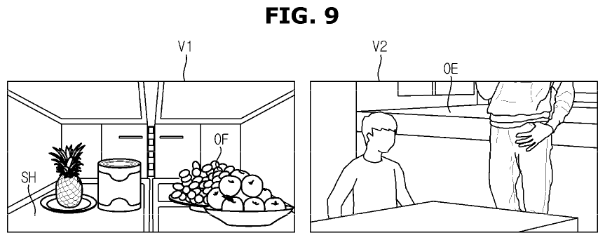

FIG. 9 shows an example in which food is identified by an object identification engine included in a computing apparatus according to an embodiment.

Referring to FIG. 9, the computing apparatus 200 may include a food region detection engine, a food region classification engine, and a food identification engine for food identification. The food region detection engine, the food region classification engine, and the food identification engine may each be implemented in hardware or software. For example, the food region detection engine, the food region classification engine, and the food identification engine may be a part of the processor as hardware or may be a part of a program stored in the storage as software.

The food region detection engine may acquire a storage compartment interior image V1 by capturing an image of the inside of the storage compartment 110 of the refrigerator 100, and identify food regions in which food items OF are located in the storage compartment interior image V1.

The food region detection engine may identify the food regions in which food items OF are located in various directions.

As another example, the food region detection engine may extract information about a change in color from the image V1, and determine whether the image is an image of the inside or an image of the outside of the storage compartment on the basis of a boundary line that rapidly changes color in the image. In addition, the food region detection engine may remove an image of the shelf SH and/or a reflected image of food from the food regions to improve the identification rate of food.

The food region classification engine may classify food regions identified by the food region detection engine. For example, the food region classification engine may classify the food regions according to the difficulty in identifying food items from each of the food regions.

The food region classification engine may classify the food region as a character identification region in response to a character being extracted from the food region using a character extraction algorithm. For example, processed food items, such as canned food and ham have a character for identifying the food item on the exterior thereof rather than having a unique shape for identifying the food item. Food items in the character identification regions may be identified through character identification.

The food identification engine may identify food items in the food regions by applying a different food identification method (or a different food identification engine) to each of the food regions classified by the food region classification engine.

Specifically, the food identification engine may identify food items in the food regions by applying at least one of a character identification engine, an image identification engine, or an image segmentation engine to the food regions.

For example, the food identification engine may identify food items OF using an identification algorithm. For example, the food identification engine may apply a character identification engine to a food region containing a character to identify the food items in the food region, and may apply a region segmentation engine to a food region containing a color boundary to segment the food region. In addition, the food identification engine may also identify food items OF from an image using an image identification engine.

According to the embodiment, the computing apparatus may determine whether the internal structure of the refrigerator is included in the image on the basis of the image V1 acquired by the refrigerator. For example, the computing apparatus may determine that the image acquired by the refrigerator is an interior image when the shelf SH is included in the image V1 acquired by the refrigerator, and determine that the image acquired by the refrigerator is an exterior image when the shelf SH is not included in the image V1.

When the computing apparatus 200 fails to identify food items on the basis of the above-described operation, the computing apparatus may determine that the image acquired by the refrigerator is an image V2 of the outside of the refrigerator. Specifically, when the food identification engine 330 performs identification on each food item but fails to match the food item with specific food identification information on the basis of pre-stored information, the computing apparatus may determine that the image acquired by the refrigerator is the image V2 of the outside of the refrigerator. On the other hand, the computing apparatus 200 may perform the recognition using a specific portion (Marker) inside the home appliance. On the other hand, when the refrigerator acquires the image V2 including furniture OE outside the refrigerator, objects in the image V2 correspond to images of furniture OE, and each object does not match with food related information, thereby identifying no food item. Therefore, in this case, the computing apparatus may determine that the image acquired by the refrigerator is the exterior image V2 of the refrigerator.

Meanwhile, the above-described operation is only an embodiment in which the computing apparatus 200 determines whether an image acquired by the refrigerator is an interior image or exterior image of the refrigerator, and the determining operation is not limited thereto.

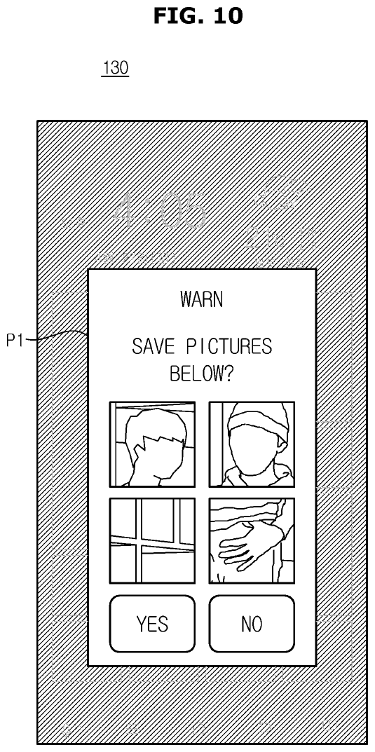

FIG. 10 shows an example in which an image is deleted according to an embodiment.

Referring to FIG. 10, the computing apparatus may derive identification information by analyzing an image captured by the refrigerator on the basis of the above-described operation, and the refrigerator may receive the identification information and display a warning message P1 on the display when the image is an exterior image of the refrigerator. The display 130 may include a touch panel. The user may delete the image acquired by the refrigerator through the touch panel.

On the other hand, when the computing apparatus determines that the image acquired by the refrigerator is an exterior image of the refrigerator, but the image may be actually an interior image, the user may not delete the image.

Meanwhile, FIG. 10 merely illustrates an example of the warning message P1 output on the display, and the form of the message output when it is determined that the computing apparatus has acquired an exterior image of the refrigerator is not limited thereto.

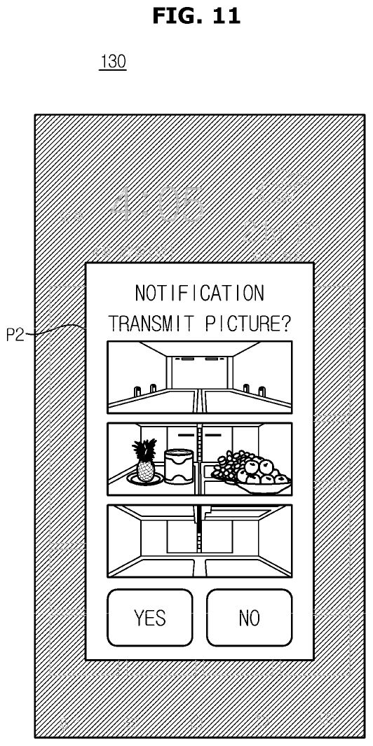

FIG. 11 shows an example in which an image transmission command is received according to an embodiment.

Referring to FIG. 11, an image acquired by the refrigerator may be transmitted to the computing apparatus. When the refrigerator transmits the image to the computing apparatus, the controller may output the acquired image P2 on the display to obtain a confirmation of the user. The controller may output the image on the display regardless of whether the image acquired by the refrigerator is an interior image or an exterior image of the refrigerator. The user may input a transmission command on the basis of the image output on the display.

Meanwhile, FIG. 11 merely illustrates an example of a transmission confirmation message output on the display, and the transmission confirmation message is not limited.

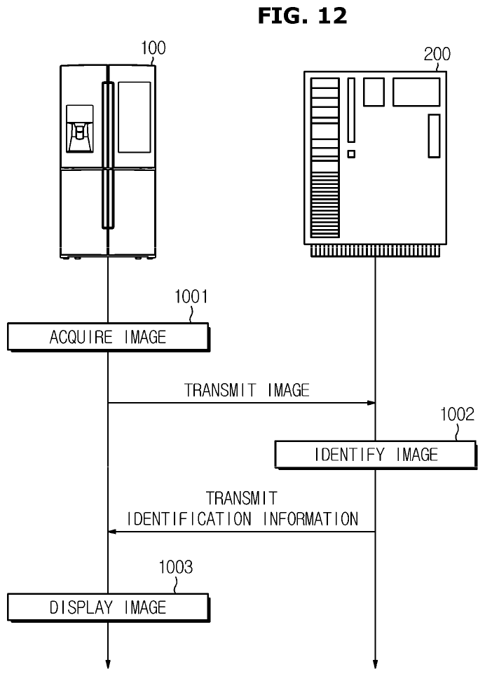

FIG. 12 shows an example of an operation of identifying an image using a computing apparatus according to an embodiment.

Referring to FIG. 12, the camera provided in the refrigerator 100 may acquire an image (1001). The refrigerator may transmit the image to the computing apparatus 200. The computing apparatus 200 may identify the image on the basis of the above-described operation (1002). The identifying of the image may include identifying the type of a food item inside the refrigerator. The identifying of the image includes identifying whether the image acquired by the refrigerator is an interior image or an exterior image of the refrigerator. The computing apparatus may transmit identification information including the above-described information to the refrigerator. The refrigerator may display the image based on the identification information on the display (1003).

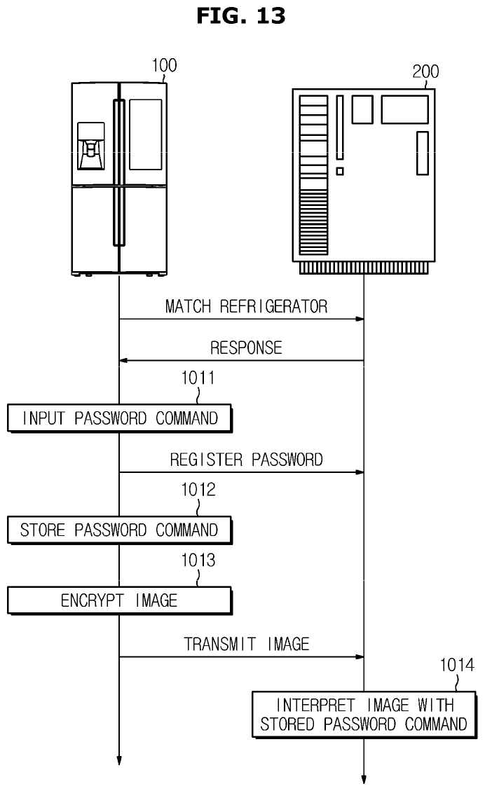

FIG. 13 shows an example of an operation of transmitting password information of the refrigerator according to an embodiment.

Referring to FIG. 13, the refrigerator 100 may attempt to match with the computing apparatus 200 and may be matched through a response of the computing apparatus 200. The user may input a password command using the touch panel of the refrigerator (1011). The password command input by the user may be stored in the memory provided in the refrigerator (1012). The refrigerator may encrypt the image on the basis of the password command input by the user (1013). The computing apparatus 200 may receive the encrypted image and interpret the image with the stored password command to identify the image (1014).

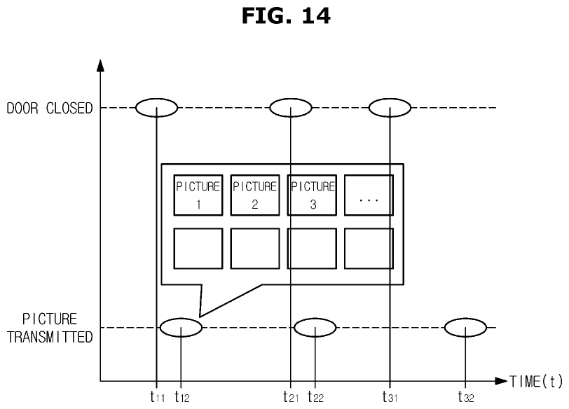

FIG. 14 is a graph showing a point in time when a door is closed and a point in time when an image is transmitted according to an embodiment.

Referring to FIG. 14, a graph showing a point in time when the door of the refrigerator is closed and a point in time when an image is transmitted is illustrated.

According to an embodiment, the image may be transmitted at a point in time t12 following a point in time t11 at which the door of the refrigerator is closed. Meanwhile, a refrigerator that transmits an image regardless of the closing of the door may transmit the image to the computing apparatus more frequently. In this case, it may be determined that the refrigerator does not operate normally, and a high possibility of personal information leakage exists, so that the controller may stop transmitting the image when an average transmission period of images to be transmitted is shorter than a predetermined period. The transmission period may be derived based on a point in time at which the refrigerator transmits an image to the computing apparatus. In FIG. 14, a difference between a point in time t12 at which a first image is transmitted and a point in time t22 at which a second image is transmitted may be derived. In addition, a difference between a point in time t22 at which the second image is transmitted and a point in time t32 at which a third image is transmitted may be derived. The controller may derive the average image transmission period of the refrigerator using each difference between the point in times at which the images are transmitted. The period derived as being longer than the predetermined period represents a case in which the door is not frequently opened or closed, so the risk of leakage of personal information is small. However, the transmission period shorter than the predetermined period represents a case in which the image is abnormally transmitted, so that the controller may stop transmission based on the transmission period.

In addition, when the image is transmitted frequently, the transmission capacity of the images during a unit time is large, so the controller may stop transmission because the average transmission capacity of the images transmitted by the communicator may exceed a predetermined capacity.

According to another embodiment, when the difference between the point in time when the door is closed and the point in time when the image is transmitted by the communicator exceeds a predetermined time, the controller may stop transmission of the image. Specifically, referring to FIG. 14, an image may be transmitted between a point in time when the door is closed (t11 or t21) and a predetermined point in time. However, when the difference between the point in time when the door is closed and the point in time when the image is transmitted is large (as in t31 or t32), the controller may determine an incorrect image transmission and stop transmitting the image.

Meanwhile, the above-described operation is only an embodiment of the disclosure, and the operation of deriving an abnormal operation of the refrigerator transmitting an image is not limited.

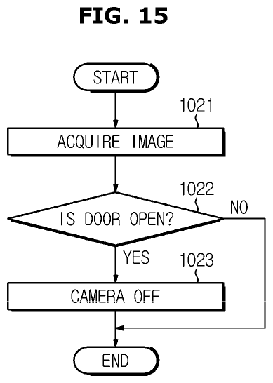

FIGS. 15 to 19 are flowcharts according to an embodiment.

Referring to FIG. 15, the refrigerator may acquire an image (1021). The refrigerator may determine whether the door is open through the switch part (1022). When it is determined that the door is open, the controller may turn off the power of the camera to stop photography (1023).

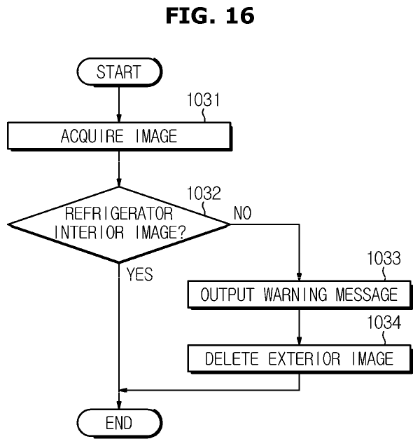

Referring to FIG. 16, the refrigerator may acquire an image (1031), and when the image acquired by the refrigerator is not an interior image (1032), may output a warning message (1033). The warning message may be output through the display provided in the refrigerator. In addition, an exterior image of the refrigerator may be deleted on the basis of a command of a user or a determination of the computing apparatus (1034).

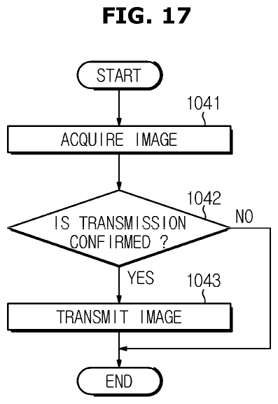

Referring to FIG. 17, the refrigerator may acquire an image (1041) and output the acquired image to inquire transmission confirmation of a user (1042). In this case, when the user confirms transmission of the image, the refrigerator may transmit the image to the computing apparatus (1043).

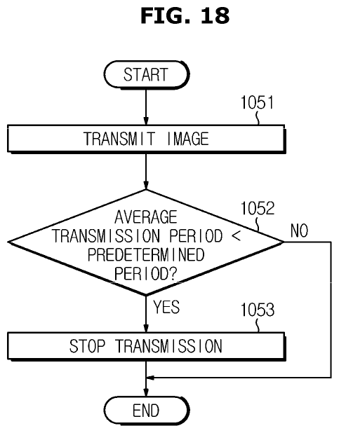

Referring to FIG. 18, the refrigerator may transmit an image (1051) and determine whether the average transmission period for transmitting the images is shorter than a predetermined period (1052). When the average transmission period is shorter than the predetermined period, the refrigerator may stop transmitting the image (1053).

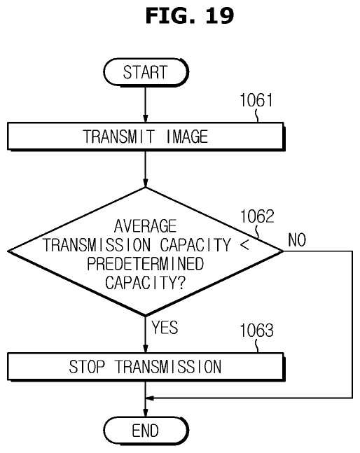

Referring to FIG. 19, the refrigerator may transmit an image (1061). The refrigerator may determine whether the average transmission capacity of the image transmitted by the refrigerator exceeds a predetermined capacity (1062). When the average transmission capacity of the images transmitted by the refrigerator exceeds the predetermined capacity, the refrigerator may stop transmitting the image (1063).

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

1. A refrigerator comprising:
a door rotatably coupled to a main body to open and close a storage compartment provided inside the main body;
a camera configured to capture an image of an inside of the storage compartment; and
a switch part configured to make a contact with the door and in response to the door being opened, interrupt supply of power for operating the camera.

2. The refrigerator of claim 1, further comprising a controller configured to stop the camera from capturing the image by opening a circuit including the camera and the switch part when the door is opened,
wherein the controller stops the camera from capturing the image by turning off a power of the camera.

3. The refrigerator of claim 2, wherein the controller stops the camera from capturing the image by switching the camera into an inactive mode.

4. The refrigerator of claim 2, further comprising a memory configured to store the image,
wherein the controller deletes the image when the image stored in the memory is determined as an image of an outside of the refrigerator.

5. The refrigerator of claim 4, further comprising a display configured to output the image, wherein the controller outputs a warning message including the image on the display.

6. The refrigerator of claim 4, further comprising a communicator configured to communicate with at least one of a computing apparatus or user equipment.
wherein the controller determines whether the camera has captured the outside of the refrigerator on the basis of identification information received from the computing apparatus.

7. The refrigerator of claim 6, wherein the controller stops transmitting the image when an average transmission period of the image transmitted by the communicator is shorter than a predetermined period.

8. The refrigerator of claim 6, wherein the controller stops transmitting the image when an average transmission capacity of the image transmitted by the communicator exceeds a predetermined capacity.

9. The refrigerator of claim 6, wherein the controller stops transmitting the image when a difference between a point in time when the door is closed and a point in time when the image is transmitted by the communicator exceeds a predetermined time.

10. The refrigerator of claim 6, wherein the controller is configured to:
match the user equipment and a user terminal with the refrigerator, and
transmit a password command input by a user to at least one of the user equipment or the computing apparatus; and
store the password command in the memory.

11. The refrigerator of claim 10, wherein the controller encrypts the image on the basis of the password command, and transmits the encrypted image to at least one of the user equipment or the user terminal.

12. A method of controlling a refrigerator, the method comprising:
capturing, by a camera, an image of an inside of a storage compartment provided inside a main body to which a door is coupled; and
interrupting, by the camera, supply of power in response to the door being opened.

13. The method of claim 12, further comprising:
stopping the camera from capturing the image by opening a circuit including the camera and the switch part when the door is opened,
wherein the stopping of the camera from capturing the image includes stopping the camera from capturing the image by turning off a power of the camera.

14. The method of claim 13, wherein the stopping of the camera from capturing the image includes stopping the camera from capturing the image by switching the camera into an inactive mode.

15. The method of claim 13, further comprising storing the image, and
deleting the image when the image stored in the memory is determined as an image of an outside of the refrigerator.

16. The method of claim 15, further comprising outputting a warning message including the image.

17. The method of claim 15, further comprising determining whether the camera has captured the outside of the refrigerator on the basis of identification information received from the computing apparatus.

18. The method of claim 17, further comprising stopping transmitting the image when an average transmission period of the image transmitted by the communicator is shorter than a predetermined period.

19. The method of claim 17, further comprising stopping transmitting the image when an average transmission capacity of the image transmitted by the communicator exceeds a predetermined capacity.

20. The method of claim 17, further comprising stopping transmitting the image when a difference between a point in time when the door is closed and a point in time when the image is transmitted by the communicator exceeds a predetermined time.

21. The method of claim 17, further comprising:
matching the computing apparatus with the refrigerator, and
transmitting a password command input by a user to at least one of the user equipment or the computing apparatus; and
storing the password command in the memory.

22. The method of claim 21, further comprising encrypting the image on the basis of the password command, and transmitting the encrypted image to at least one of the user equipment or the user terminal.
